(19) United States
(12) Patent Application Publication
(10) Pub. No.: US 2026/0213789 A1
(43) Pub. Date: Jul. 23, 2026

(54) WIDE-ANGLE DISTANCE-INSENSITIVE UNIT CELL DESIGN FOR PASSIVE WEARABLE METASURFACES

(71) Applicant: Dell Products L.P., Round Rock, TX (US)

(72) Inventors: Tejinder Singh, Manotick (CA); Navjot Kaur Khaira, Manotick (CA); Kan Wang, Ottawa (CA); Ibrahim Abu Alhaol, Nepean (CA)

(21) Appl. No.: 19/030,484

(22) Filed: Jan. 17, 2025

(51) Int. Cl. H04B 7/04; H04B 1/3827

(52) U.S. Cl. CPC H04B 7/04013; H04B 1/385

(57) ABSTRACT

The technology described herein is directed towards a passive wearable device with a metasurface, such as in the form of a ring or wristband. The wearable device reflects a transmitted scanning signal to a receiver coupled to a computing device, such as for automatic user proximity detection, user authentication and/or other security purposes. In one implementation, unit cells having resonators in the shape of symmetrical concentric rings around a central disk provide a wide-angle, orientation insensitive ultra-thin and compact wearable device. The symmetry of the unit cells results in the orientation insensitivity, (polarization insensitivity in electromagnetic terms), as well as operating generally independent of the angle of incidence of the transmitted scanning signal. In another implementation, the unit cells for passive wearable devices have resonators in the shape of notched rings, which results in a wide-angle, distance insensitive wearable device that is also significantly orientation insensitive.

### RELATED APPLICATION

The subject patent application is related to U.S. patent application Ser. No. ______, filed ______, and entitled “WIDE-ANGLE ORIENTATION-INSENSITIVE WEARABLE DEVICE” (docket no. 140399.01/DELLP1425US), the entirety of which patent application is hereby incorporated by reference herein.

### BACKGROUND

Existing wearable devices (e.g., rings) focus on health and activity monitoring. Such wearable devices rely on establishing a BLUETOOTH communication link with a computing device, such as a personal computer or cellphone. These wearable devices tend to be heavy and thick due to the inclusion of sensors and other components, and in general are expensive because of high manufacturing costs.

### BRIEF DESCRIPTION OF THE DRAWINGS

The technology described herein is illustrated by way of example and not limited in the accompanying figures in which like reference numerals indicate similar elements and in which:

FIG. 1A is a block diagram representation of an example wearable device including a passive metasurface communicating with a computing device via an embedded transceiver, in accordance with various example embodiments and implementations of the subject disclosure.

FIG. 1B is a block diagram representation of an example wearable device including a passive metasurface communicating with a computing device via an external transceiver, in accordance with various example embodiments and implementations of the subject disclosure.

FIG. 2 is a representation of an example wearable device in the form of a ring design, in which the wearable device includes a passive metasurface that can be detected by a receiver in computing device, in accordance with various example embodiments and implementations of the subject disclosure.

FIGS. 3A and 3B are representations of an example ring-based metasurface suitable for user proximity detection and/or authentication, showing freedom of movement in three-dimensional space (FIG. 3A) and a mathematical representation thereof (FIG. 3B), in accordance with various example embodiments and implementations of the subject disclosure.

FIG. 4A is a representation of an example unit cell for a metasurface, in which the unit cell includes concentric circles around a disk as a resonator (eye aperture), in accordance with various example embodiments and implementations of the subject disclosure.

FIG. 4B is a representation of an example wearable device with a passive metasurface of unit cells, in the form of a wrist-wearable (e.g., wristband or bracelet) design, in accordance with various example embodiments and implementations of the subject disclosure.

FIG. 5 is a graphical representation of a simulated phase profile of a ring configured with a metasurface of unit cells having concentric circles around disks, with 28 GHz as the center frequency, in accordance with various example embodiments and implementations of the subject disclosure.

FIG. 6 is a graphical representation of far-field gain response of a unit cell with concentric circles around a disks at different orientations, in accordance with various example embodiments and implementations of the subject disclosure.

FIG. 7 is a representation of an example wearable device in the form of a ring design, highlighting a passive metasurface communicating with a transceiver embedded in a computing device, in accordance with various example embodiments and implementations of the subject disclosure.

FIG. 8A is an isometric top view representation of an example unit cell with a ring-and-notched shaped pattern as a resonating element, in accordance with various example embodiments and implementations of the subject disclosure.

FIG. 8B shows example dimensions suitable for the unit cell of FIG. 8A, in accordance with various example embodiments and implementations of the subject disclosure.

FIG. 9A is a side view of the example unit cell of FIG. 8A, in accordance with various example embodiments and implementations of the subject disclosure.

FIG. 9B is an isometric bottom view of the example unit cell of FIG. 8A, showing cutouts in the ground plane that generally align with the notches of the resonating element, in accordance with various example embodiments and implementations of the subject disclosure.

FIG. 10 is a representation of an example distance-insensitive metasurface wearable metasurface in the form of a ring, implemented at 80 GHz demonstrating its ultra-compact size, along with an enlarged portion representation thereof, and an enlarged unit cell representation, in accordance with various example embodiments and implementations of the subject disclosure.

FIG. 11 is a graphical representation showing the normalized reflection amplitude performance of an example ring-and-notched shaped pattern unit cell for different values of incident angles, in accordance with various example embodiments and implementations of the subject disclosure.

FIG. 12 is a graphical representation showing a simulation of the reflection phase of an example ring-and-notched shaped pattern unit cell for various incident angles.

FIG. 13 is a representation showing the far-field radiation pattern of an example metasurface with unit cells having ring-and-notched shaped patterns as resonating elements, in which the distance is varied relative to the nominal incident distance, in accordance with various example embodiments and implementations of the subject disclosure.

FIG. 14 is a flow diagram showing example operations related to detecting proximity of a metasurface to a computing device, in which the metasurface includes unit cells having symmetrical or substantially symmetrical resonating metallic ring and notch-shaped patterns incorporated into a wearable device, in accordance with various example embodiments and implementations of the subject disclosure.

### DETAILED DESCRIPTION

The technology described herein is generally directed towards a wearable metasurface such as a ring or wristband designed for proximity detection, authentication, and/or security purposes. Significantly, the wearable device and metasurface can be passive, requiring no internal or external power source to operate as a reflecting device, that is, needing no battery / recharging as it does not power electrical components, unlike the sensors, accelerometers, or controllers of other wearable devices. Instead, the metasurface technology and architectural design (material, system integration, and physical layout) described herein enables presence detection through a compact, passive, and cost-effective design. The wearable device embedded with a metasurface, or with a metasurface affixed thereto, is thus relatively thin and not bulky, and as such can become a component in a user's daily attire, for example, to offer a seamless and comfortable user interaction experience.

By leveraging metasurface-assisted presence detection, the metasurface provides a seamless and secure method for authentication and unlocking a computing device by bringing the metasurface close to the device. This metasurface is lightweight, durable, and maintenance-free, offering a reliable and efficient solution for enhancing digital security without the need for regular charging or complex electronics. Note that technology described herein is extendable to other applications beyond security.

In general, the operation is based on having a receiver coupled to or incorporated into a computing device, e.g., as a native part of the computing device, or as an auxiliary USB or added card coupled to the computing device. A transmitter, which can be a transceiver that also receives the signal, transmits a wireless scanning signal, which in the presence of the metasurface is reflected back to the receiver, whereby the presence of the metasurface (and thus the user wearing the metasurface) is detected. In one implementation, the use of sub-terahertz range communication ensures that the metasurface remains compact, and that the system only detects the metasurface when the metasurface is in close proximity to the computing device, preventing unauthorized access from a distance. The wearable metasurface ring thus has the potential to act as a replacement for existing user authentication processes and as an aid to enhance current systems, e.g., offering a seamless and secure method for authentication that can be more convenient and less obtrusive than traditional methods like passwords, PINs, or biometric scans.

It should be understood that any of the examples and/or descriptions herein are non-limiting. Thus, any of the embodiments, example embodiments, concepts, structures, functionalities, or examples described herein are non-limiting, and the technology may be used in various ways that provide benefits and advantages in RF communications and RF devices in general.

Reference throughout this specification to “one embodiment,” “an embodiment,” “one implementation,” “an implementation,” etc. means that a particular feature, structure, characteristic and/or attribute described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, characteristics, and/or attributes may be combined in any suitable manner in one or more embodiments/implementations. Repetitive description of like elements employed in respective embodiments may be omitted for sake of brevity.

The detailed description is merely illustrative and is not intended to limit embodiments and/or application or uses of embodiments. Furthermore, there is no intention to be bound by any expressed or implied information presented in the preceding sections, or in the Detailed Description section. Further, it is to be understood that the present disclosure will be described in terms of a given illustrative architecture; however, other architectures, structures, materials and process features, and steps can be varied within the scope of the present disclosure.

It also should be noted that terms used herein, such as “optimize,” “optimization,” “optimal,” “optimally” and the like only represent objectives to move towards a more optimal state, rather than necessarily obtaining ideal results. Similarly, “maximize” means moving towards a maximal state (e.g., up to some processing capacity limit), not necessarily achieving such a state, and so on.

It will also be understood that when an element such as a layer, region or substrate is referred to as being “on” or “over” “atop” “above” “beneath” “below” and so forth with respect to another element, it can be directly on the other element or intervening elements can also be present. In contrast, only if and when an element is referred to as being “directly on” or “directly over” another element, are there no intervening element(s) present. Note that orientation is generally relative; e.g., “on” or “over” can be flipped, and if so, can be considered unchanged, even if technically appearing to be under or below / beneath when represented in a flipped orientation. It will also be understood that when an element is referred to as being “connected” or “coupled” to another element, it can be directly connected or coupled to the other element or intervening elements can be present. In contrast, only if and when an element is referred to as being “directly connected” or “directly coupled” to another element, are there no intervening element(s) present.

The following detailed description is merely illustrative and is not intended to limit embodiments and/or application or uses of embodiments. Furthermore, there is no intention to be bound by any expressed or implied information presented in the preceding sections, or in the Detailed Description section.

One or more example embodiments are now described with reference to the drawings, in which example components, graphs and/or operations are shown, and in which like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details, and that the subject disclosure may be embodied in many different forms and should not be construed as limited to the examples set forth herein.

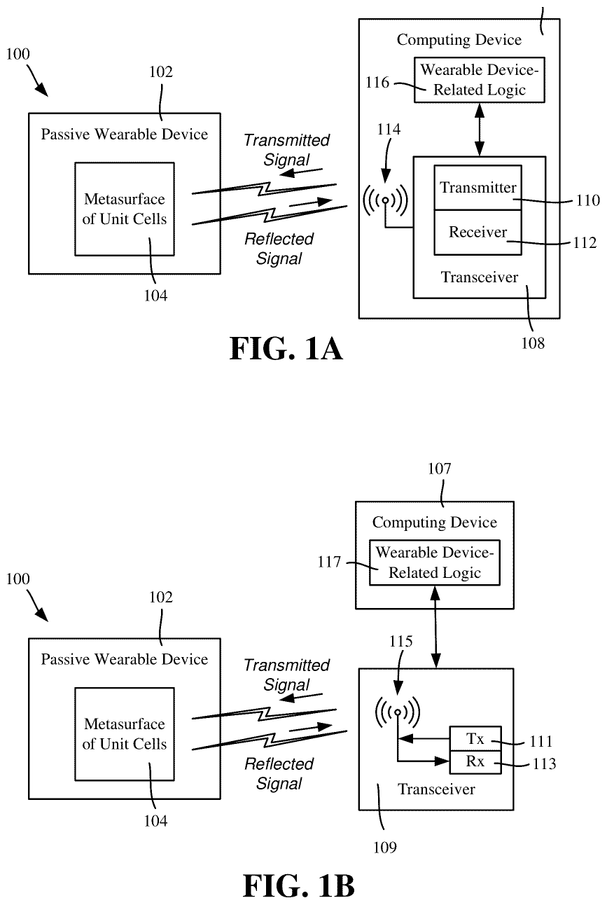

FIG. 1A is a block diagram representation of one example implementation of a system 100 in which a wearable device 102, which includes a metasurface of unit cells 104, communicates with a computing device 106. In the example of FIG. 1A, the computing device 106 includes an embedded, integrated or otherwise internal transceiver 108, which in turn includes a transmitter 110 and receiver 112. The transceiver components are coupled to an antenna 114 that transmits signals to the metasurface 104 of the passive wearable device 102, which as described herein, reflects reflected instance of the signals to the transceiver's receiver 112. Based on the received signal, wearable device-related logic 116 (e.g., a hardware or software program running in the computing device 106) can analyze the reflected signal and take some action based thereon as described herein, such as to wake the operating system program or the like for execution in the computing device.

FIG. 1B is similar to FIG. 1A, except that a transceiver 109 (transmitter Tx 111/receiver Rx 113) is external to the computing device 107. For example, the external transceiver 109 can be designed as a universal serial bus (USB) device or other suitable device (e.g., card) that plugs into the computing device 109. Alternatively, the external transceiver 109 can be embedded in a computer peripheral device such as a mouse, keyboard or monitor coupled to the computing device 107.

While a dedicated transceiver is one practical and convenient example, it should be noted that the transmitter and the receiver can be separate components. For example, consider an office setting where a single wall-mounted transmitter can transmit signals to multiple user work locations. Each user can share the same transmitter, yet have his or her own passive wearable device that reflects from the transmitter to a receiver. The users'respective computing devices can have respective external or internal receivers.

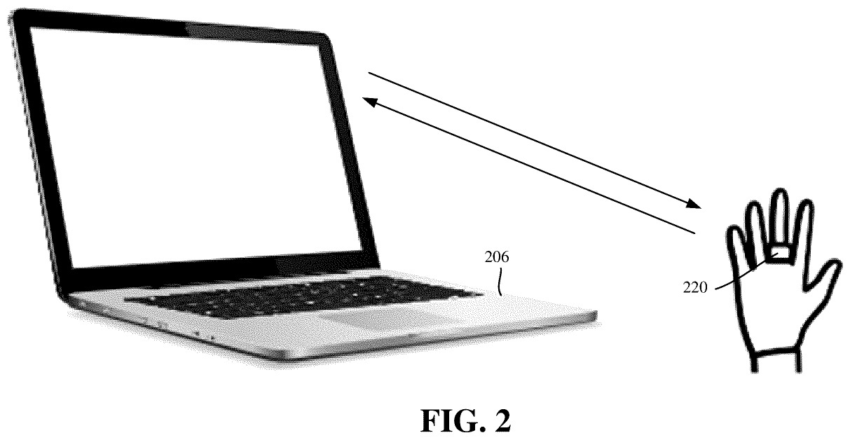

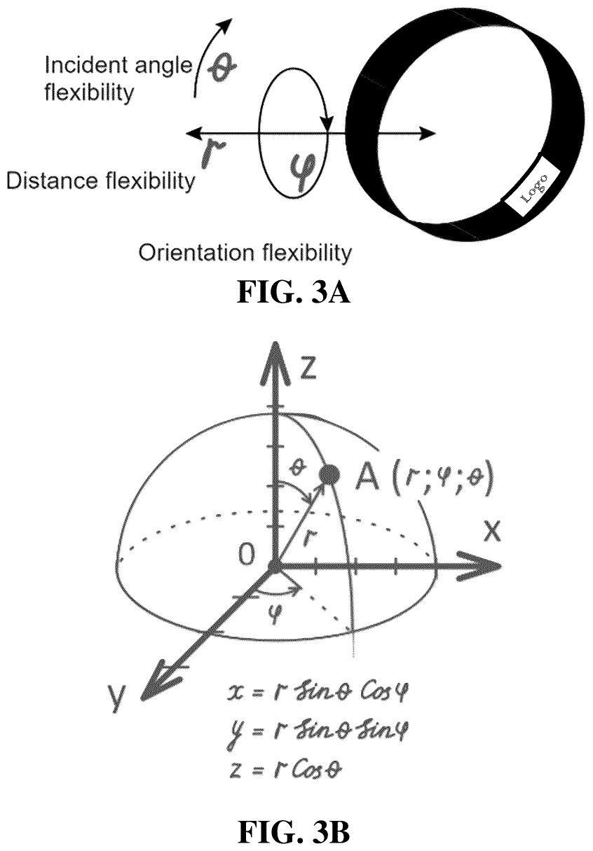

FIGS. 2 and 3 show the general concept of a ring-based wearable metasurface 220 interacting with a laptop computer 206. The ring-based wearable metasurface 220 can act as a key to lock and unlock the computer 206, for example, or at least detect the user's presence to wake the computer 206, such as to automatically open present an interactive lock screen when proximity is detected.

Initially, the ring-based wearable metasurface 220 and/or computing device 206 may need to be initially activated or reactivated with respect to sensing signals reflected by the metasurface 220. For example, software may be installed when the transceiver is coupled to the device so that the device 206 knows what action(s) to take when the reflected signals are received.

In the example of FIG. 3, a portion of the metasurface unit cells 304(a) is shown enlarged and interacting with a transceiver 208 (via antenna 214) integrated into the bezel or the like of the computer 206. Instead of the bezel, the transceiver 208 (or the antenna 214 coupled thereto) can be embedded into the lower portion of the laptop so that when interacting with the keyboard/mouse pad. In general and as described herein, the user only needs to be within range for the system to operate.

The operation of the antenna (in the transceiver) and the metasurface at high frequencies can present significant challenges due to issues with directivity, somewhat similar to the alignment needed for an infrared remote control for a television. Ensuring that the overall system remains operational without requiring precise orientation and reflection direction will avoid user frustration and system downtime. When the user wears the metasurface, the user should not need to align the metasurface at a particular orientation to gain access, as this would otherwise adversely impact the user experience.

Described herein are designs that overcome this challenge, resulting in a metasurface that can effectively communicate with the transceiver regardless of the angle or orientation of the user's hand. As shown in FIGS. 3A and 3B, a general goal is to provide a metasurface that is conformal to the ring while providing flexibility in orientation, and incident angle. Such a design can allow for complete freedom of movement within a three-dimensional (3D) space, ensuring seamless and intuitive user interaction without the need for precise alignment. Other design considerations can be included to enhance the robustness and reliability of the system, ensuring consistent performance even in varying usage scenarios.

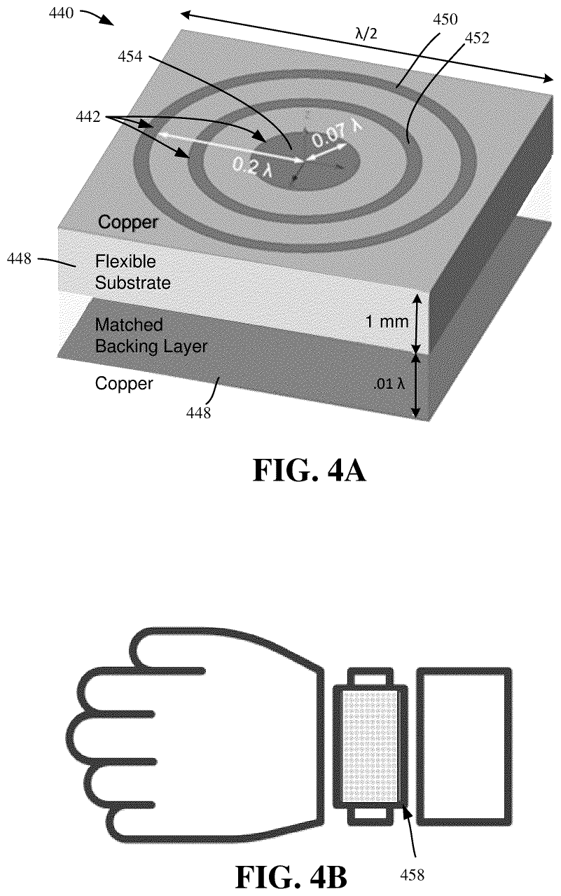

FIG. 4A shows an example of a generally polarization insensitive metasurface unit-cell 440 designed with linear phase variation. The example unit cell 440 features a metallic (resonating) pattern 442 (e.g., copper) on the top metal layer, separated from a ground plane 444 by a flexible dielectric substrate 446 and another flexible matched backing layer 448.

The shape of the metallic pattern determines the polarization of the reflected signal. In one implementation, the unit cell design includes two concentric metallic rings 450 and 452 with a central circular disk 454, resulting in a symmetrical or substantially symmetrical pattern that maintains symmetry regardless of the orientation. This configuration provides the desired polarization insensitivity, ensuring reliable signal reception/reflection regardless of the ring's orientation. To maintain the compact size of the metasurface, the unit cell 440 is designed for high frequencies, as the size of the unit cell scales linearly with the wavelength. In one example implementation the 28 GHz frequency is targeted to make sure the appropriate beam directivity is achievable using the compact size of the wearable device; notwithstanding, the design can be easily scaled to other (particularly higher) frequencies.

Note that while many of the examples herein are directed to a wearable metasurface in the form of a ring, these are nonlimiting examples. Other wearable devices, including but not limited to metasurfaces attached to an eyeglass frame, bracelet, necklace, and the like may provide similar benefits. Indeed, as one particular alternative example, FIG. 4B shows a metasurface designed as a wristband 458; the unit cells correspond to the metallic resonating pattern of the unit cell 440 of FIG. 4A.

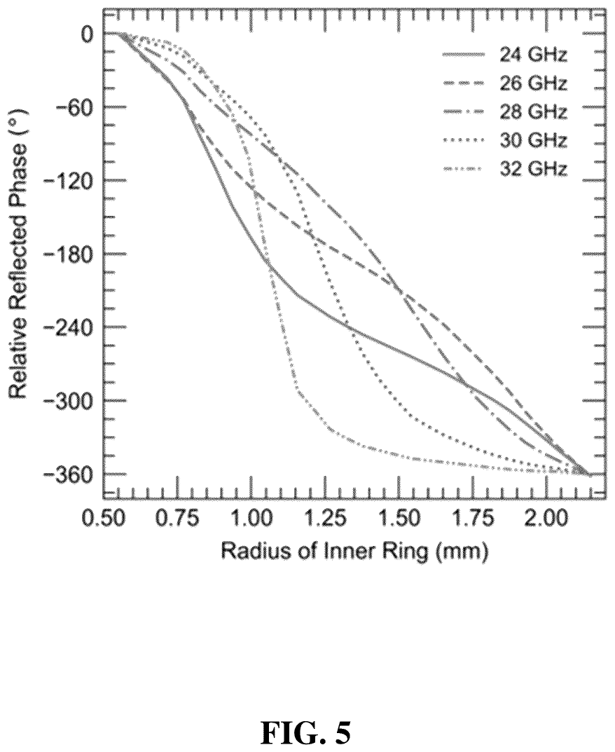

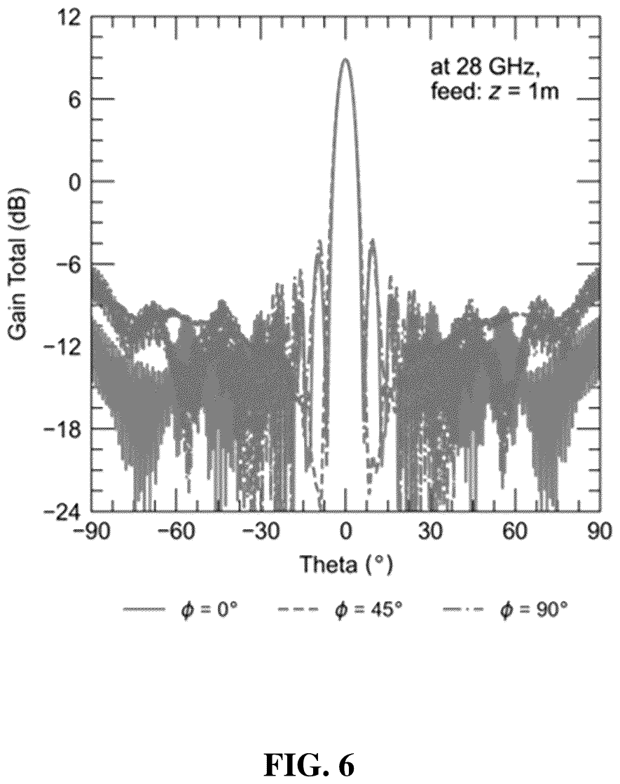

The electromagnetic performance of the example unit cell 440 is simulated in an industry standard 3D full-field finite element modeler. The simulation results are shown in FIGS. 5 and 6. More particularly, FIG. 5 shows the simulated phase profile with 28 GHz as the center frequency, which highlights the reflected phase tuning achieved by adjusting the radius of the middle ring at five different frequencies ranging between 24 GHz and 32 GHz. At 28 GHz, the cell shows a very linear change in the reflected phase as the radius of the middle ring is changed from 0.5 mm to 2.25 mm.

FIG. 6 shows the far-field gain response of the designed unit-cell at different orientations. The simulated response shows the gain from the metasurface unit cell when the transceiver is one meter away. The three curves indicated in the plot show the response for θ range from −90°to 90 for three different values of Φ(0°, 45°, and 90°). In other words, the orientation-independent behavior of the unit cell is illustrated in FIG. 6, which depicts the far-field response across the entire half space azimuth angle (θ) range from −90° to 90° for three different elevation angles, Φ=0°, 45°, and 90°. Notably, due to the symmetry of the structure, the unit cell's behavior in the remaining half-space mirrors the performance shown, once again confirming the orientation-independence of the unit cell, and hence the metasurface (e.g., the ring) in the entire rotational space.

Indeed, the design was experimentally validated by fabricating the metasurface on a flat surface (not formed into a ring) and performing comprehensive tests. The fabricated design operates at a slightly higher frequency of 40 GHz, which provides a practical implementation. In testing, an industry standard horn antenna transmitted a scan signal towards the metasurface with the strength of the reflected signal measured. Multiple measurements were conducted by tilting and rotating the metasurface at various angles to assess the metasurface's orientation sensitivity. Further, the metasurface was moved to evaluate its response to different incident angles of the incoming signal; also, the distance between the metasurface and the antenna was varied to test the metasurface's distance sensitivity. These tests confirmed robust performance across a range of orientations for the metasurface with variation in different angles, ensuring reliable and consistent operation in real-world scenarios. A typical thickness of this metasurface is 1.2 mm.

The result is a unit-cell design that reflects transmitted signals of a corresponding frequency without being impacted by orientation and/or the angle of incidence of the signal. Unlike existing smart rings that rely on batteries and electronic components, the passive metasurface technology functions without the need for power, making it maintenance-free and durable. One design maintains the sleekness and comfort of a regular ring or other wearable device by incorporating a flexible metasurface, ensuring no increased thickness or bulkiness. This facilitates a seamless way of reliable and secure authentication by bringing the ring close to the authenticating device, with secure presence detection obtained by reflecting scanning signals back to a transceiver on the device. The wearable device design ensures orientation-independent performance via the analog polarization-insensitive metasurface. As a result, the wearable device can effectively communicate with the computing device's transceiver regardless of the angle or orientation of user's hand.

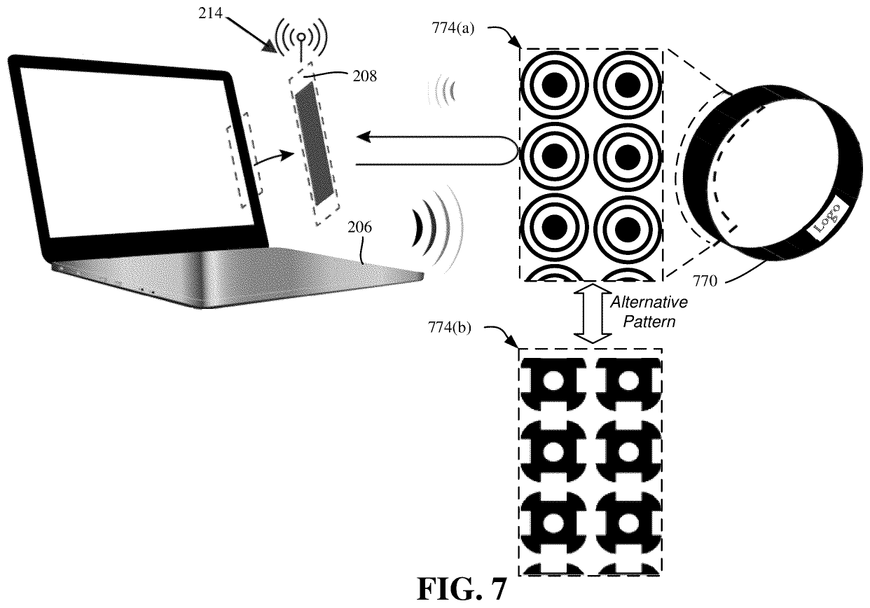

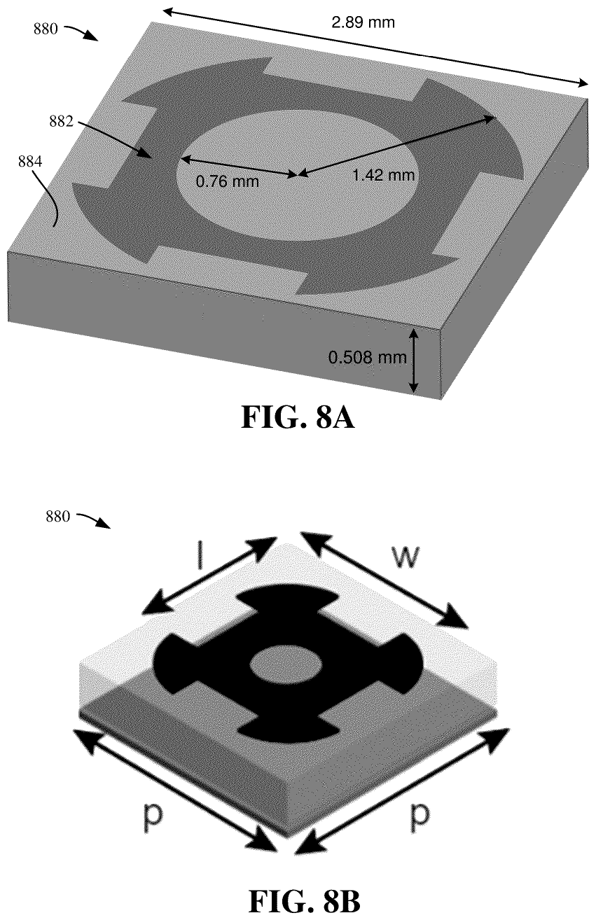

FIG. 7 summarizes one implementation, corresponding to the unit cells of the metasurface having concentric circles/disks as metallic resonators, as shown in the portion 774(a). The ring 770 (or similarly a wristband or the like) is generally orientation-insensitive, meaning that the user need not orient his or her hand at any specific angle for the reflected signals to be detected. In an alternative implementation described with reference to FIGS. 8A-13, the unit cells of the metasurface have a ring-and-notched shaped patterns as metallic resonators as shown in the alternative portion 774(b). Such a ring with this ring-and-notched shaped-based metasurface 774(b) (or similarly a wristband or the like) is generally distance-insensitive, meaning that the user need not be too close for the reflected signals to be detected. Note that such a metasurface having the ring-and-notched shaped unit cell resonators is also generally orientation-insensitive as described herein.

FIG. 8A shows a unit cell 880 for a wide-angle, distance insensitive unit cell design for passive wearable metasurfaces. In general, this design focuses on ensuring that the metasurface on the ring or other wearable device can effectively communicate with the computing device's transceiver regardless of the distance of the user's hand thereto. As previously shown in FIGS. 3A and 3B, a general goal is a metasurface that is conformal to the wearable device while providing flexibility with respect to a combination of distance, orientation, and incident angle. The design of the unit cell 880 allows for significant freedom of movement within a 3D space, ensuring seamless and intuitive user interaction without the need for precise alignment and/or a particular distance. As with the concentric ring design described herein with reference to FIGS. 4A-6, other design considerations can be included to enhance the robustness and reliability of the system, ensuring consistent performance even in varying usage scenarios.

FIG. 8A is an isometric top view of one unit cell 880. A resonating metallic (e.g., copper) patch 882, above a substrate 884, is in the form of a ring with notches (no metal) symmetrically or substantially symmetrically distributed around the periphery of the otherwise ring-shaped pattern. In this example there are four such notches, however this is a nonlimiting example, and other number of such notches can be used. Note that the symmetry makes the unit cell orientation-insensitive (although not necessarily as incident angle-insensitive as the design generally shown in FIG. 4A).

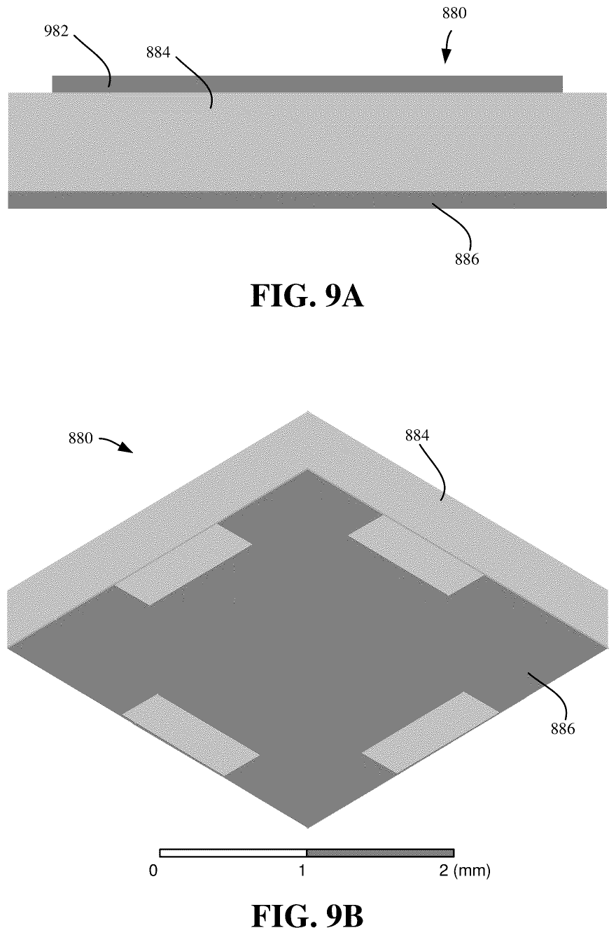

Thus, the design described herein with reference to FIGS. 4A-6 is directed to significant orientation insensitivity, the design of FIGS. 8A-9B achieves not only ninety-degree quantized polarization insensitivity, but also flexibility regarding the angle of the incoming wave and a wide operational distance range between the metasurface and the transceiver. To accommodate the wide scan angle requirement, the circular polarization unit cell 880 is enhanced with additional design features, shown in FIGS. 8A-9B.

FIG. 8B shows dimensions that can be tailored to a defined frequency and size specification. For example, in one design, the overall unit cell size is p=1.88 mm, providing a very compact unit cell; FIG. 8A shows corresponding dimensions of the example metallic patch 882 and substrate 884.

FIG. 9A shows a side view of the designed unit cell 880, with the upper metal layer 982 (corresponding to the resonating metal patch 882 in FIG. 8A) above the substrate 884, which in turn is above a metal ground layer (plane) 886. FIG. 9B shows an isometric bottom view of the example unit cell 880. In this example design, the ground plane 886 includes cutouts that generally (or precisely) align with the notches in the ring-shaped (with notches) metal resonating layer 882 shown in FIG. 8A.

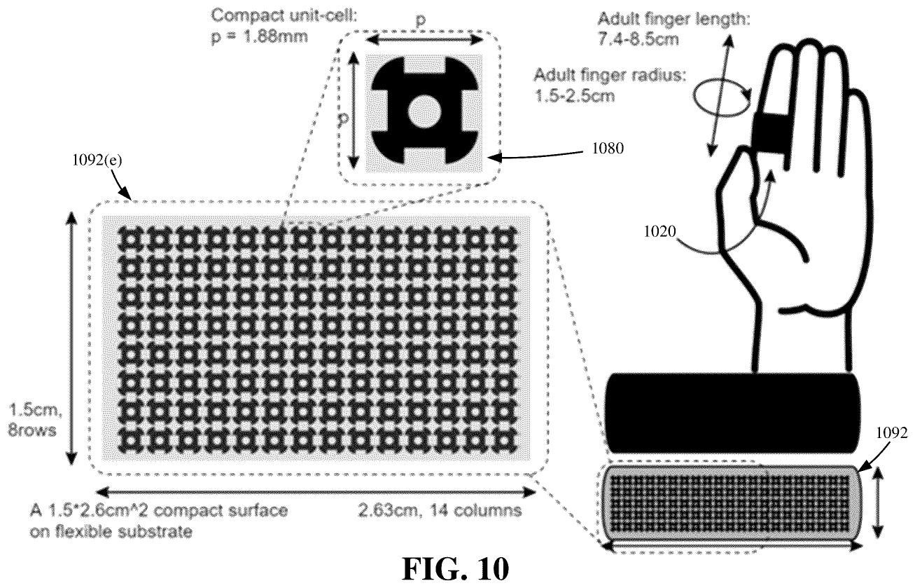

FIG. 10 shows an example wearable device 1020 that incorporates a metasurface 1092 with an 8×28 array of unit cells. An enlarged portion 1092(e) highlighting an 8×14 unit cell array of the metasurface 1092 is shown, and one of the unit cells 1080 is enlarged.

In one example implementation, the metasurface is fabricated on flexible material (substrate and metallic ground plane) to facilitate forming the wearable device into a ring shape suitable for wearing on a human finger. The dimensions shown in FIG. 10 are based on a typical adult finger size and a frequency of 80 gigahertz (GHz). The fabrication tolerance of the metasurface design described herein makes this design easily scalable up to sub-terahertz frequencies, which is suitable for miniaturization to fit on a ring. As shown in FIG. 10, each unit cell in this example measures 1.88 mm×1.88 mm. These unit cells can be arranged in a matrix to fit within a ring that measures 1.5 cm in width and 2 to 3 cm (e.g., 2.63 cm) in length when flattened; this ring fits very well on a human hand. Additionally, the design is conformal, allowing for adjustments to accommodate bending of the surface, ensuring both flexibility and functionality in wearable applications.

The result is a compact, passive, and cost-effective wide-angle and distance insensitive metasurface unit-cell design with ninety degree quantized polarization. To reiterate, a ring is only one nonlimiting example of a wearable device, with other wearable devices able to accommodate the ring-and-notch shaped unit cell patterns.

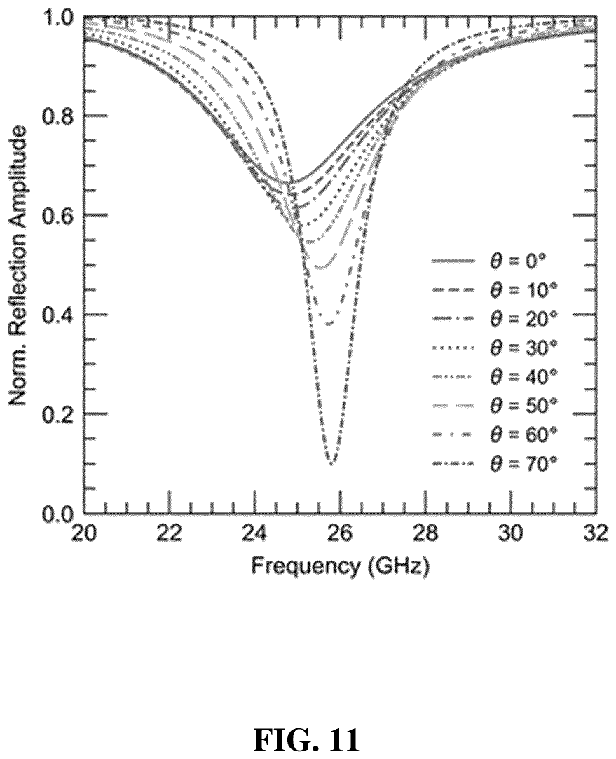

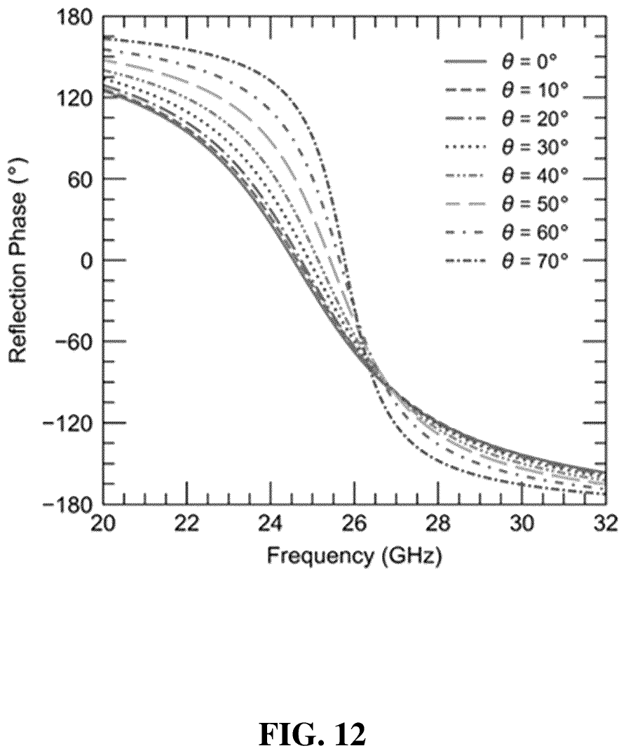

Simulated results of the ring-and-notched-shaped unit cell performance, for incident signal angles ranging from 0° to 70° in 10° increments, are shown in FIGS. 11 and 12, respectively. More particularly, the amplitude of the reflected signal over the frequency range of 20 GHz to 32 GHz is shown in FIG. 11, while FIG. 12 depicts the reflection phase variation across the same frequency range. It can be observed that only when the incident angle exceeds 60 degrees is there a notable difference in performance, ensuring efficient gain returns over a wide-incident angle range.

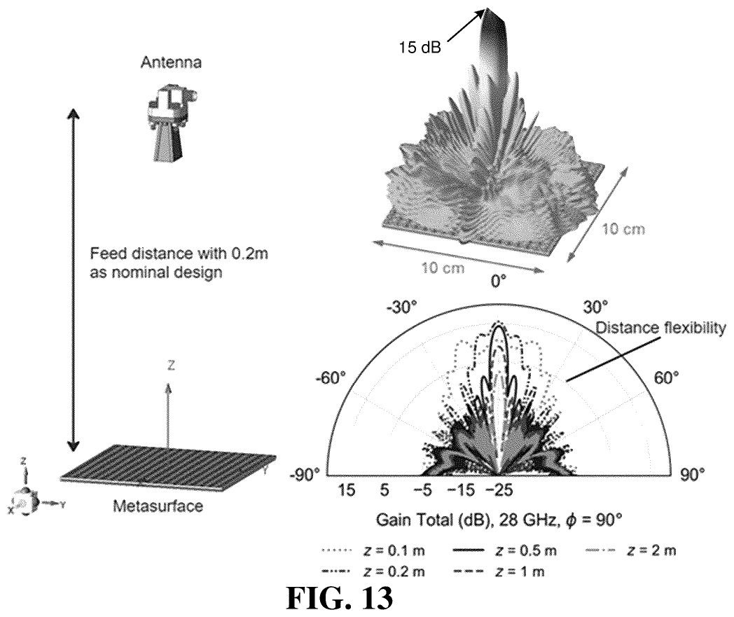

Various simulations were conducted to assess the performance at various distances between the transceiver antenna and the metasurface, as depicted in FIG. 13, which shows the far-field radiation pattern of the designed surface with the distance varied from 50 percent to 1000 percent of the nominal incident distance with distinguishable peak pattern. These scenarios include vertical distances of 0.1 meters, 0.2 meters, 0.5 meters, 1 meter, and 2 meters. The polar plot of the reflected signal gain indicates a substantial gain of up to 15 dB for distances up to 1.0 meter. When the distance extends to 2.0 meters and beyond, the gain drops below 5 dB.

To summarize, the metasurface design of FIG. 8A-13 provides distance-insensitive performance with a wide incident angle range. This ensures that the user can interact seamlessly with a computing device via a transceiver, without the need for precise alignment of or distance to the metasurface. To summarize, there is thus described a unit cell and corresponding metasurface designed to reflect the signals without being impacted by distance, orientation, and/or an angle of incidence of the transmitted scanning signal. The ring-and-notched unit cells and corresponding metasurface function without the need for power, making the wearable device generally maintenance-free and durable. The design can maintain the sleekness and comfort of a regular ring or wristband while incorporating a flexible metasurface, ensuring no increased thickness or bulkiness. The design ensures distance-independent performance through 90-degree quantized polarization-insensitive metasurface, whereby the wearable device can effectively communicate with a computing device's transceiver regardless of the angle or orientation of user's hand and at variable distances thereto. As one usage example, the wearable device facilitates seamless, reliable, and secure authentication by bringing the wearable device close to the computing device; secure presence detection is facilitated by reflecting scanning signals back to a transceiver on the computing device.

One or more implementations and embodiments can be embodied in a device, such as described and represented herein. The device can include a wearable metasurface comprising respective passive unit cells, the wearable metasurface configured to reflect transmitted wireless radio frequency signals, received at the wearable metasurface from a transmitter, as reflected wireless radio frequency signals to a receiver. The respective passive unit cells can include respective metallic resonators that reflect wireless radio frequency signals relative to the transmitted wireless radio frequency signals to facilitate proximity detection, by a computing device coupled to the receiver, associated with a user wearing the wearable metasurface. The respective metallic resonators can include symmetrical, or substantially symmetrical, ring-and-notched shaped patterns within the respective passive unit cells, resulting in a combination of reduced orientation sensitivity at different orientations of the wearable metasurface relative to the receiver, and reduced distance sensitivity at different distances from the wearable metasurface relative to the receiver, the reduced distance being relative to a metasurface of metallic resonators with non-symmetrical shaped patterns or non-ring-and-notched shaped patterns.

The wearable metasurface can include a flexible substrate physically coupled to the passive unit cells, and a ground plane physically coupled to the substrate.

The respective metallic resonators can include respective metallic circular rings with respective symmetrically distributed notches in the outer peripheries of the respective metallic circular rings. The wearable metasurface can include a substrate physically coupled to the passive unit cells, and a ground plane physically coupled to the substrate; the ground plane can include respective cutout sections that align or substantially align with the respective symmetrically distributed notches.

The device can be incorporated into a ring designed to be worn on a finger of the user.

The device can be incorporated into a band designed to be worn on a wrist of the user.

The device can be designed to be worn around a neck of the user, or for a coupling to eyeglass frames wearable by the user.

The reflected wireless radio frequency signals can be represented within a defined millimeter wave frequency band.

The respective passive unit cells can further facilitate an authentication of the user wearing the wearable metasurface.

One or more implementations and embodiments can be embodied in a system, such as described and represented herein. The system can include at least one wireless radio frequency transmitter, at least one wireless radio frequency receiver, and a wearable metasurface. The wearable metasurface can include respective passive unit cells that redirect transmitted wireless radio frequency signals, transmitted by the at least one wireless radio frequency transmitter and impinging on at least part of the wearable metasurface, as reflected wireless radio frequency signals for reception by the at least one wireless radio frequency receiver. The respective passive unit cells can include respective metallic resonators that reflect wireless radio frequency signals relative to the transmitted wireless radio frequency signals to facilitate proximity detection, by a computing device coupled to the at least one wireless radio frequency receiver, of the wearable metasurface. The respective metallic resonators can include respective ring-and-notched shaped patterns within the respective passive unit cells, resulting in greater proximity detection distances from the wearable metasurface to the at least one wireless radio frequency receiver, the greater proximity detection distances being relative to lesser proximity detection distances of a metasurface with non-ring-and-notched shaped patterns.

The wearable metasurface can include a substrate physically coupled to the passive unit cells, and a ground plane physically coupled to the substrate, and the ground plane can include respective cutout sections that align or substantially align with respective notches of the respective ring-and-notched shaped patterns.

The respective metallic resonators can be symmetrical or substantially symmetrical within the respective passive unit cells, resulting in greater polarization insensitivity relative to non-symmetrical respective metallic resonators.

The at least one wireless radio frequency transmitter and the at least one wireless radio frequency receiver can include at least one wireless radio frequency transceiver.

The system further can include the computing device, and the at least one wireless radio frequency transceiver can be incorporated into the computing device.

The wearable metasurface can include a flexible substrate physically coupled to the respective passive unit cells, and a flexible ground plane physically coupled to the substrate; the wearable metasurface can be curved as part of a wearable ring, or curved as part of a wearable wristband.

The reflected wireless radio frequency signals can be represented within a defined a millimeter wave frequency band.

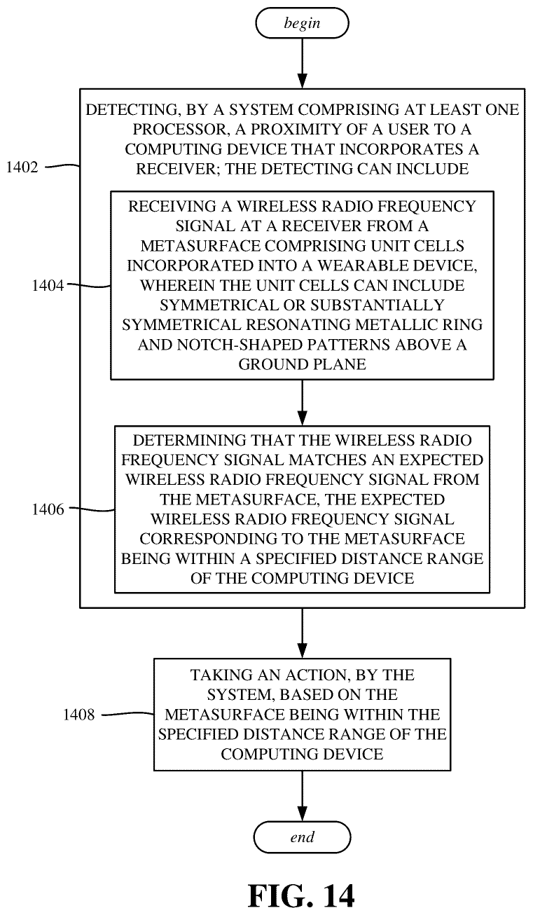

One or more example implementations and embodiments, such as corresponding to example operations of a method, can be represented in FIG. 14. Example operation 1402 represents detecting, by a system comprising at least one processor, a proximity of a user to a computing device that incorporates a receiver; the detecting can include example operations 1404 and 1406. Example operation 1404 represents receiving a wireless radio frequency signal at a receiver from a metasurface comprising unit cells incorporated into a wearable device, wherein the unit cells can include symmetrical or substantially symmetrical resonating metallic ring and notch-shaped patterns above a ground plane. Example operation 1406 represents determining that the wireless radio frequency signal matches an expected wireless radio frequency signal from the metasurface, the expected wireless radio frequency signal corresponding to the metasurface being within a specified distance range of the computing device. Example operation 1408 represents taking an action, by the system, based on the metasurface being within the specified distance range of the computing device.

Taking the action can include activating a program on the computing device.

The action can be a first action, and further operations can include detecting, by the system, that the metasurface can be no longer within the specified proximity range of the computing device, and, in response to the detecting that the metasurface can be no longer within the specified proximity range of the computing device, taking a second action.

Taking the action can assist in authentication of a user associated with the metasurface.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As used in this application, the terms “component,” “system,” “platform,” “layer,” “selector,” “interface,” and the like are intended to refer to a computer-related resource or an entity related to an operational apparatus with one or more specific functionalities, wherein the entity can be either hardware, a combination of hardware and software, software, or software in execution. As an example, a component can be an apparatus with specific functionality provided by mechanical parts operated by electric or electronic circuitry. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit, and scope in accordance with the appended claims.

What is claimed is:

1. A device, comprising:
a wearable metasurface comprising respective passive unit cells, the wearable metasurface configured to reflect transmitted wireless radio frequency signals, received at the wearable metasurface from a transmitter, as reflected wireless radio frequency signals to a receiver,
wherein the respective passive unit cells comprise respective metallic resonators that reflect wireless radio frequency signals relative to the transmitted wireless radio frequency signals to facilitate proximity detection, by a computing device coupled to the receiver, associated with a user wearing the wearable metasurface, and
wherein the respective metallic resonators comprise symmetrical, or substantially symmetrical, ring-and-notched shaped patterns within the respective passive unit cells, resulting in a combination of reduced orientation sensitivity at different orientations of the wearable metasurface relative to the receiver, and reduced distance sensitivity at different distances from the wearable metasurface relative to the receiver, the reduced distance being relative to a metasurface of metallic resonators with non-symmetrical shaped patterns or non-ring-and-notched shaped patterns.

2. The device of claim 1, wherein the wearable metasurface comprises a flexible substrate physically coupled to the passive unit cells, and a ground plane physically coupled to the substrate.

3. The device of claim 1, wherein the respective metallic resonators comprise respective metallic circular rings with respective symmetrically distributed notches in the outer peripheries of the respective metallic circular rings.

4. The device of claim 3, wherein the wearable metasurface comprises a substrate physically coupled to the passive unit cells, and a ground plane physically coupled to the substrate, and wherein the ground plane comprises respective cutout sections that align or substantially align with the respective symmetrically distributed notches.

5. The device of claim 1, wherein the device is incorporated into a ring designed to be worn on a finger of the user.

6. The device of claim 1, wherein the device is incorporated into a band designed to be worn on a wrist of the user.

7. The device of claim 1, wherein the device is designed to be worn around a neck of the user, or for a coupling to eyeglass frames wearable by the user.

8. The device of claim 1, wherein the reflected wireless radio frequency signals are represented within a defined millimeter wave frequency band.

9. The device of claim 1, wherein the respective passive unit cells further facilitate an authentication of the user wearing the wearable metasurface.

10. A system, comprising:
at least one wireless radio frequency transmitter;
at least one wireless radio frequency receiver; and
a wearable metasurface comprising respective passive unit cells that redirect transmitted wireless radio frequency signals, transmitted by the at least one wireless radio frequency transmitter and impinging on at least part of the wearable metasurface, as reflected wireless radio frequency signals for reception by the at least one wireless radio frequency receiver,
wherein the respective passive unit cells comprise respective metallic resonators that reflect wireless radio frequency signals relative to the transmitted wireless radio frequency signals to facilitate proximity detection, by a computing device coupled to the at least one wireless radio frequency receiver, of the wearable metasurface, and
wherein the respective metallic resonators comprise respective ring-and-notched shaped patterns within the respective passive unit cells, resulting in greater proximity detection distances from the wearable metasurface to the at least one wireless radio frequency receiver, the greater proximity detection distances being relative to lesser proximity detection distances of a metasurface with non-ring-and-notched shaped patterns.

11. The system of claim 10, wherein the wearable metasurface comprises a substrate physically coupled to the passive unit cells, and a ground plane physically coupled to the substrate, and wherein the ground plane comprises respective cutout sections that align or substantially align with respective notches of the respective ring-and-notched shaped patterns.

12. The system of claim 10, wherein the respective metallic resonators are symmetrical or substantially symmetrical within the respective passive unit cells, resulting in greater polarization insensitivity relative to non-symmetrical respective metallic resonators.

13. The system of claim 10, wherein the at least one wireless radio frequency transmitter and the at least one wireless radio frequency receiver comprise at least one wireless radio frequency transceiver.

14. The system of claim 13, further comprising the computing device, wherein the at least one wireless radio frequency transceiver is incorporated into the computing device.

15. The system of claim 10, wherein the wearable metasurface comprises a flexible substrate physically coupled to the respective passive unit cells, and a flexible ground plane physically coupled to the substrate, and wherein the wearable metasurface is curved as part of a wearable ring, or curved as part of a wearable wristband.

16. The system of claim 10, wherein the reflected wireless radio frequency signals are represented within a defined a millimeter wave frequency band.

17. A method, comprising:
detecting, by a system comprising at least one processor, a proximity of a user to a computing device that incorporates a receiver, the detecting comprising:
receiving a wireless radio frequency signal at a receiver from a metasurface comprising unit cells incorporated into a wearable device, wherein the unit cells comprise symmetrical or substantially symmetrical resonating metallic ring and notch-shaped patterns above a ground plane, and
determining that the wireless radio frequency signal matches an expected wireless radio frequency signal from the metasurface, the expected wireless radio frequency signal corresponding to the metasurface being within a specified distance range of the computing device; and
taking an action, by the system, based on the metasurface being within the specified distance range of the computing device.

18. The method of claim 17, wherein the taking of the action comprises activating a program on the computing device.

19. The method of claim 17, wherein the action is a first action, and further comprising detecting, by the system, that the metasurface is no longer within the specified proximity range of the computing device, and, in response to the detecting that the metasurface is no longer within the specified proximity range of the computing device, taking a second action.

20. The method of claim 17, wherein the taking of the action assists in authentication of a user associated with the metasurface.
